(19) United States
(12) Patent Application Publication
(10) Pub. No.: US 2012/0087256 A1
(43) Pub. Date: Apr. 12, 2012

(54) WIRELESS COMMUNICATION APPARATUS, METHOD, AND RECORDING MEDIUM

(75) Inventors: Mitsumasa MATSUDA, Kawasaki (JP); Naozumi ANZAI, Kawasaki (JP)

(73) Assignee: FUJITSU LIMITED, Kawasaki-shi (JP)

(21) Appl. No.: 13/164,001

(22) Filed: Jun. 20, 2011

(30) Foreign Application Priority Data
Oct. 8, 2010 (JP) 2010-228141

(51) Int. Cl. H04W 24/00; H04L 12/26

(52) U.S. Cl. 370/252

(57) ABSTRACT

A wireless communication apparatus includes a first storage unit, a switching detection unit and a control unit. The first storage unit stores configuration information that configures a relationship between occurrence of switching of a wireless communication apparatus and a frequency of the occurrence of switching. The switching detection unit detects the occurrence of switching of other wireless communication apparatus currently connected by wireless communication. The control unit performs control on a basis of the configuration information such that the frequency of switching when the detected occurrence of switching satisfies a given condition is lower than when the occurrence of switching does not satisfy the given condition.

### CROSS-REFERENCE TO RELATED APPLICATIONS

This application is based upon and claims the benefit of priority from the prior Japanese Patent Application No. 2010-228141 filed on Oct. 8, 2010, the entire contents of which are incorporated herein by reference.

### FIELD

Embodiments of the present disclosure relate to a wireless communication apparatus, method, and recording medium.

### BACKGROUND

Network configuration management software is known as software for integrally managing configuration for connecting an information processing apparatus, such as a personal computer (PC), to a communication network, such as a wired local area network (LAN), a wireless LAN, or a dial-up network. The network configuration management software manages network configuration information in association with a place. The place where a mobile PC, such as a notebook PC, is used is often changed. For such a mobile PC, if configuration information on a network of a place to which the PC is moved is registered using the network configuration management software, the place where the PC is used is identified on the basis of a network connected to the PC and the configuration of the PC is automatically switched to its optimal state. This eliminates the necessity for a user to manually switch network configuration even when the place where the PC is used is changed among an office, home, and a path between them, so a burdensome process is omitted or reduced.

If network trouble occurs, for example, a PC becomes unable to communicate or a Web site cannot be displayed, network diagnosis using the network configuration management software can enable investigating a cause of the trouble and a way of dealing with the trouble or automatically dealing with the trouble.

There may be a plurality of access points of a connectable wireless LAN in the vicinity of a PC. In this case, if automatic configuration is set, as described above, roaming processing for connecting the PC to an access point having strong radio waves is performed, and the proportion of the roaming processing to data communication processing is increased. This may cause instability of the communication. If the roaming processing is frequently repeated, the connection of the PC with the network may become unstable and a delay of the data communication itself may be caused.

It is difficult to automate configuration of a roaming parameter for controlling the roaming processing to suppress the above-described disadvantage caused by the roaming processing in the connection with a wireless LAN. Therefore, a user needs to manually change the configuration of the roaming parameter.

### SUMMARY

According to an embodiment, a wireless communication apparatus includes a first storage unit, a switching detection unit and a control unit. The first storage unit stores configuration information that configures a relationship between occurrence of switching of a wireless communication apparatus and a frequency of the occurrence of switching. The switching detection unit detects the occurrence of switching of other wireless communication currently connected by wireless communication. The control unit performs control on a basis of the configuration information such that the frequency of switching when the detected occurrence of switching satisfies a given condition is lower than when the occurrence of switching does not satisfy the given condition.

The object and advantages of the various embodiments will be realized and attained at least by the elements, features, and combinations particularly pointed out in the claims. It is to be understood that both the foregoing general description and the following detailed description are exemplary and explanatory and are not restrictive of the various embodiments, as claimed.

Additional aspects and/or advantages will be set forth in part in the description which follows and, in part, will be apparent from the description, or may be learned by practice of the various embodiments.

### BRIEF DESCRIPTION OF THE DRAWINGS

FIG. 1 illustrates a wireless communication apparatus according to a first embodiment;

FIG. 2 illustrates a general structure of a communication system according to a second embodiment;

FIG. 3 illustrates a hardware structure of an information processing apparatus according to the second embodiment;

FIG. 4 is a block diagram that illustrates a structure of the information processing apparatus according to the second embodiment;

FIG. 5 illustrates a roaming parameter configuration table according to the second embodiment;

FIG. 6 illustrates an event log according to the second embodiment;

FIG. 7 illustrates another event log according to the second embodiment;

FIG. 8 illustrates a relationship between the information processing apparatus and access points according to the second embodiment;

FIG. 9 is a flowchart that illustrates a procedure of regular diagnosis processing according to the second embodiment;

FIG. 10 is a flowchart that illustrates a procedure of network diagnosis processing according to the second embodiment;

FIG. 11 is a flowchart that illustrates a procedure of wireless LAN diagnosis processing according to the second embodiment;

FIG. 12 is a flowchart that illustrates a procedure of roaming parameter initialization processing according to the second embodiment.

### DETAILED DESCRIPTION OF THE EMBODIMENTS

Embodiments of the present invention are described below with reference to the drawings.

### First Embodiment

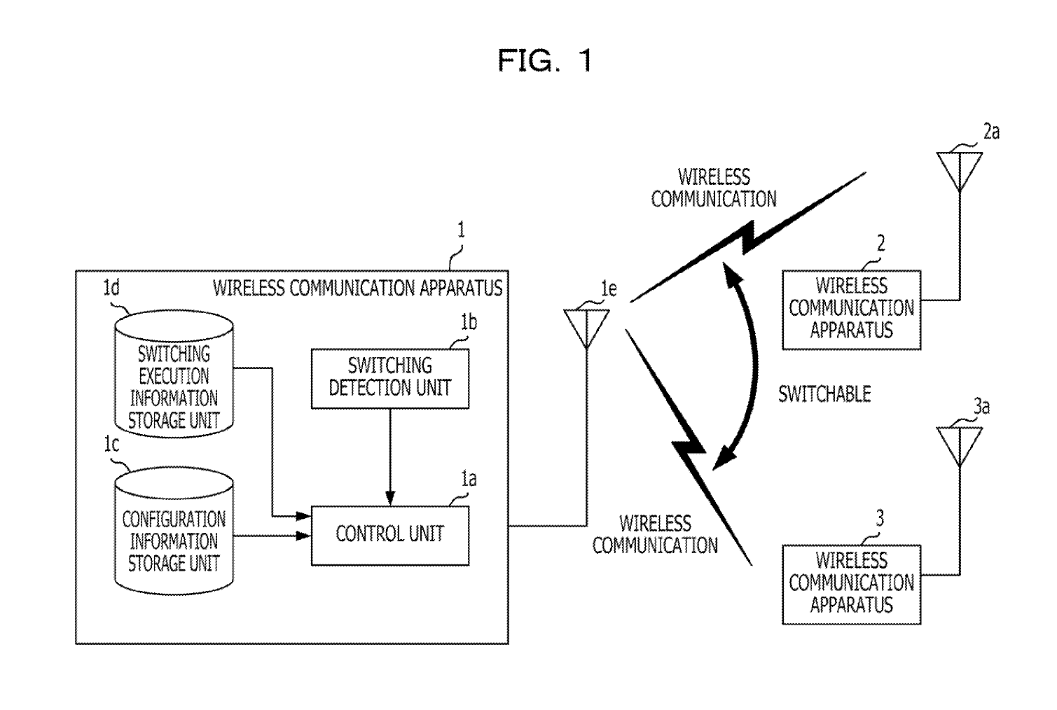

FIG. 1 illustrates a wireless communication apparatus according to a first embodiment. A wireless communication apparatus 1 illustrated in FIG. 1 is a wireless communication apparatus that changes a communication speed in accordance with the priority of data. The wireless communication apparatus 1 includes a control unit 1a, a switching detection unit 1b, a configuration information storage unit 1c, and a switching execution information storage unit 1d. The wireless communication apparatus 1 is connected to an antenna 1e. The wireless communication apparatus 1 according to the first embodiment may be a device capable of carrying out wireless communication, for example. Examples of the wireless communication apparatus 1 include, but are not limited to, an information processing apparatus (e.g., a notebook PC and a personal digital assistant (PDA)), a portable terminal apparatus, a cellular phone, a portable television, a potable game machine, and an electronic dictionary.

The control unit 1a performs control on the basis of configuration information stored in the configuration information storage unit 1c such that the frequency of switching connection when occurrence of switching of connection detected by the switching detection unit 1b satisfies a given condition is lower than when the state does not satisfy the condition.

The control unit 1a determines whether a configured execution condition is satisfied. When the configured execution condition is satisfied, the control unit 1a switches connection. The control unit 1a determines whether occurrence of switching of connection detected by the switching detection unit 1b satisfies a configuration condition indicated in configuration information stored in the configuration information storage unit 1c. The control unit 1a changes the configured execution condition such that the frequency of switching connection when the occurrence of switching of connection detected by the switching detection unit 1b satisfies the configuration condition is lower than when the state does not satisfy the configuration condition.

The switching detection unit 1b detects occurrence of switching of connection of the wireless communication apparatus 1 with a wireless communication apparatus 2 or a wireless communication apparatus 3 by wireless communication, such as a wireless LAN or code division multiple access (CDMA).

The configuration information storage unit 1c stores configuration information that configures a relationship between occurrence of switching of connection and a frequency of switching. The configuration information storage unit 1c stores configuration information that indicates a configuration condition for configuring one execution condition from among a plurality of execution conditions in switching execution information stored in the switching execution information storage unit 1d on the basis of the occurrence of switching of connection.

The switching execution information storage unit 1d stores switching execution information that indicates a plurality of execution conditions for determining whether a connection is to be switched. The execution conditions indicated in the switching execution information may be configured on the basis of the strength of radio waves or the dropping rate of packets, for example. The wireless communication apparatus 1 measures the strength of radio waves received from another apparatus (wireless communication apparatus 2 or 3). The above-described strength of radio waves may be the strength of received radio waves measured in this apparatus, for example. The wireless communication apparatus 1 receives a beacon signal regularly transmitted from another apparatus (e.g., wireless communication apparatus 2 or 3) currently connected thereto. The above-described dropping rate of packets may be the proportion of the number of times the wireless communication apparatus 1 has lost a beacon signal from another apparatus (the number of times it has failed to receive a beacon signal) within a given period of time, for example. When the execution conditions are configured on the basis of the strength of radio waves, for example, if the strength of radio waves is less than a given value, processing of switching the connection of the wireless communication apparatus is performed. When the execution conditions are configured on the basis of the dropping rate of packets, if the dropping rate of packet is equal to or larger than a given value, the processing of switching connection of the wireless communication apparatus is performed.

In processing of switching connection, if there is a connectable wireless communication apparatus (e.g., wireless communication apparatus 3) other than a currently connected wireless communication apparatus (e.g., wireless communication apparatus 2), the wireless communication apparatus 1 becomes connected to that connectable wireless communication apparatus. In the processing of switching connection, if there is no connectable wireless communication apparatus other than the wireless communication apparatus 2, the wireless communication apparatus 1 continues connection with the wireless communication apparatus 2.

Switching execution information indicates a plurality of execution conditions. The wireless communication apparatus 1 selects any one of the plurality of execution conditions on the basis of configuration information. The wireless communication apparatus 1 determines on the basis of the selected execution condition whether the connection is to be switched.

This enables appropriately controlling switching of a connection with a wireless communication apparatus by roaming and stabilizes wireless communication. For a second embodiment described below, an information processing apparatus is described as an example of an application of the wireless communication apparatus 1 according to the first embodiment. However, the wireless communication apparatus 1 is also applicable to various wireless communication apparatuses other than an information processing apparatus, as described above.

### Second Embodiment

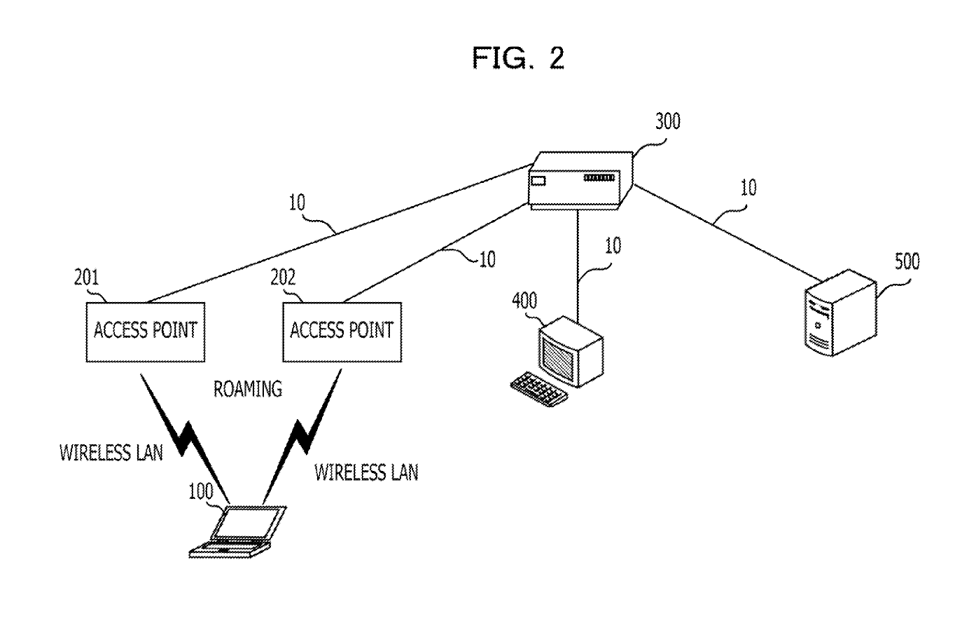

FIG. 2 illustrates a general structure of a communication system according to the second embodiment. In the communication system according to the present embodiment, an information processing apparatus 100 having the function of wireless LAN communication is connected to an access point 201 or 202 by a wireless LAN and exchanges data with an information processing apparatus 400 and a server 500 through a network 10 and a relay apparatus 300.

The communication system illustrated in FIG. 2 includes the information processing apparatuses 100 and 400, the access points 201 and 202, the relay apparatus 300, and the server 500. The information processing apparatus 100 is an apparatus used by a user, such as a computer. The information processing apparatus 100 is connected to either one of the access points 201 and 202 and conducts data communications with the information processing apparatus 400 are the server 500 through the relay apparatus 300. The access points 201 and 202 have the roaming function. The information processing apparatus 100 conducts data communications over the network 10 using the roaming function while switching connection to one of the access points 201 and 202 that has a better radio-wave state.

The access points 201 and 202 are connectable to the information processing apparatus 400 and the server 500 through the relay apparatus 300 over the network 10. The network 10 may be, but not limited to, a wired LAN, for example. It may be other communication networks, such as a wireless LAN or one using a dedicated line. Each of the access points 201 and 202 has the communication function using a wireless LAN and is connectable to the information processing apparatus 100 by the wireless LAN.

The relay apparatus 300 relays a frame from a source node to a destination node in data communications between nodes of, for example, the access points 201 and 202, the information processing apparatus 400, and the server 500.

The information processing apparatus 400 is an apparatus used by a user, such as a computer. The information processing apparatus 400 is connected to the relay apparatus 300 over the network 10 and, additionally, communicates with the information processing apparatus 100 through the access point 201 or 202.

The server 500 is an apparatus capable of distributing data stored therein to another apparatus through data communications. The server 500 is connected to the relay apparatus 300 over the network 10 and, additionally, communicates with the information processing apparatus 100 through the access point 201 or 202.

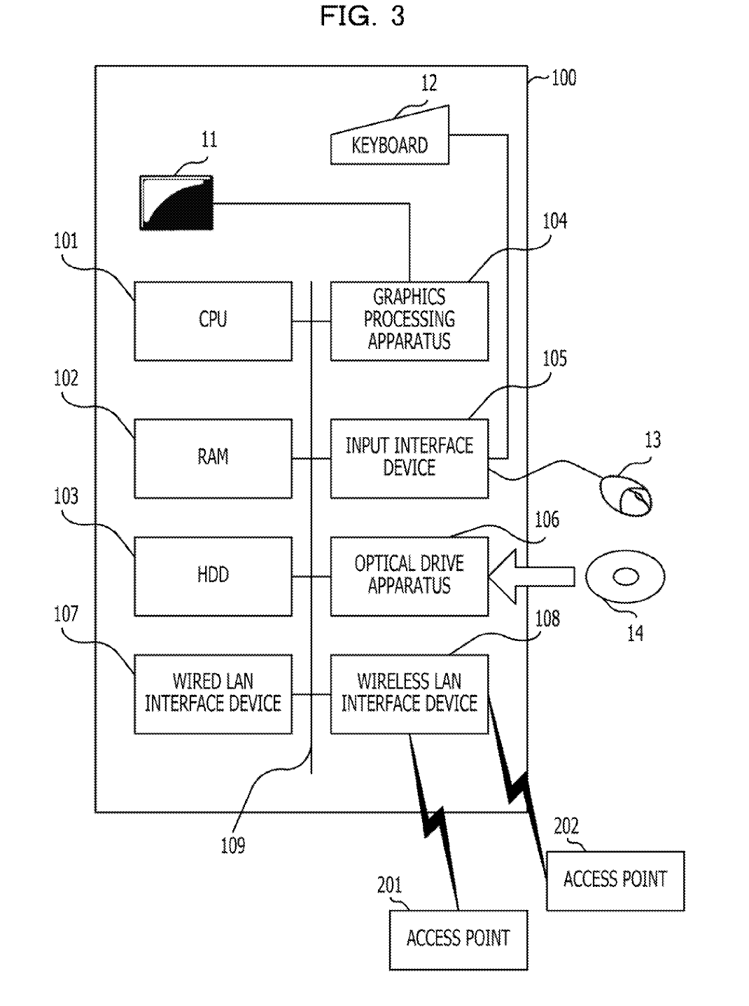

FIG. 3 illustrates a hardware structure of the information processing apparatus according to the second embodiment. A central processing unit (CPU) 101 controls the information processing apparatus 100. The CPU 101 is connected to a random-access memory (RAM) 102 and other peripheral devices through a bus 109.

The RAM 102 is used as a main storage of the information processing apparatus 100. The RAM 102 temporarily stores at least part of an operating system (OS) and an application program executable by CPU 101. The RAM 102 stores various kinds of data required for processing executed by the CPU 101.

Examples of the peripheral devices connected to the bus 109 include a hard disk drive (HDD) 103, a graphics processing apparatus 104, an input interface device 105, an optical drive apparatus 106, and a wired LAN interface device 107, and a wireless LAN interface device 108.

The HDD 103 magnetically writes and reads data in and from an internal disk. The HDD 103 is used as secondary storage of the information processing apparatus 100. The HDD 103 stores an OS, an application program, and various kinds of data. Alternatively, a semiconductor memory, such as a flash memory, may be used as the secondary storage.

The graphics processing apparatus 104 is connected to an internal monitor 11. The graphics processing apparatus 104 displays an image on the screen of the monitor 11 in response to an instruction from the CPU 101. Examples of the monitor 11 include a display apparatus that uses a cathode ray tube (CRT) and a liquid crystal display apparatus.

The input interface device 105 is connected to an internal keyboard 12 and an external mouse 13. The input interface device 105 transmits a signal supplied from the keyboard 12 or the mouse 13 to the CPU 101. The mouse 13 is an example of a pointing device. Other pointing devices may also be used. Examples of the other pointing devices include a touch panel, a tablet, a touch pad, and a track ball.

The optical drive apparatus 106 reads data recorded on an optical disk 14 using, for example, a laser beam. The optical disk 14 is a portable recording medium on which data is recorded such that the data are read by reflection of light. Examples of the optical disk 14 include a Blu-ray Disk®, a digital versatile disk (DVD), a DVD-RAM, a compact-disk read-only memory (CD-ROM), and a compact-disk recordable and rewritable (CD-R/RW). The optical drive apparatus 106 may have the function of recording data on the optical disk 14.

The wired LAN interface device 107 is an interface that makes a connection for a wired LAN communication to an apparatus connected by a wired LAN. The wired LAN interface device 107 is connectable to the network 10 by a wired LAN. When being connected to the network 10, the wired LAN interface device 107 exchanges data with another computer or communication device by a wired LAN.

The wireless LAN interface device 108 is an interface that makes a connection for a wireless LAN communication to a connected apparatus having the communication function of being able to make connection by a wireless LAN. The wireless LAN interface device 108 is connected to either one of the access points 201 and 202 by a wireless LAN and is connected to the network 10. When being connected to the network 10 through either one of the access points 201 and 202, the wireless LAN interface device 10 exchanges data with another computer or communication device by a wireless LAN.

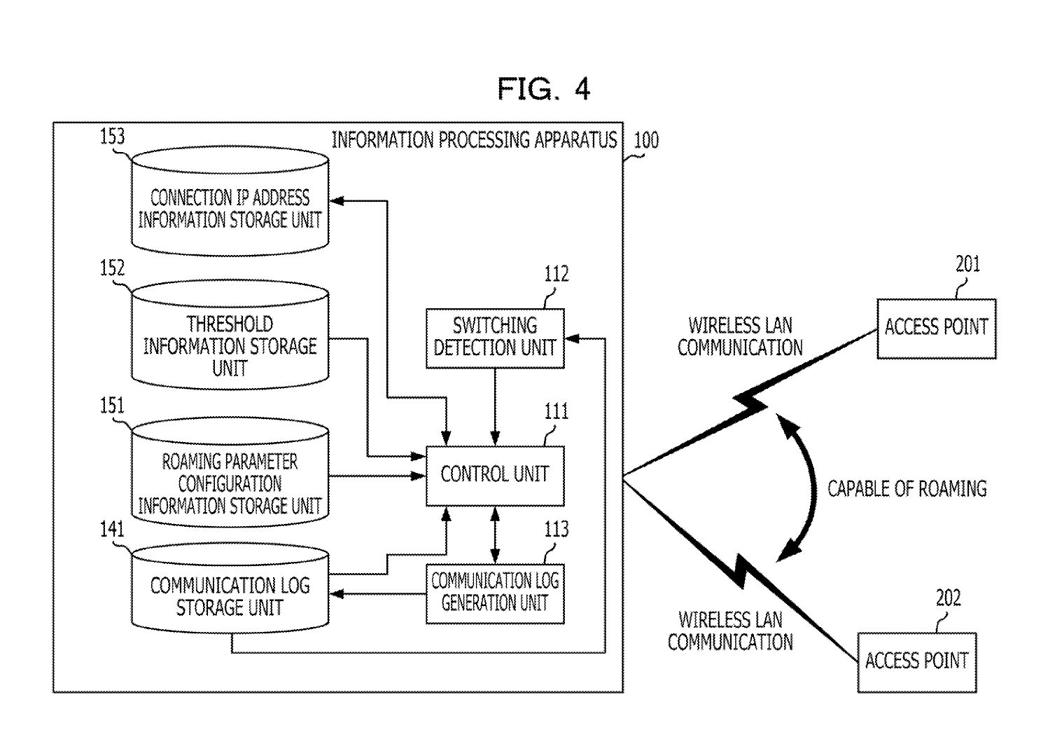

The above-described hardware structure achieves the processing functions of the present embodiment. FIG. 4 is a block diagram that illustrates a structure of the information processing apparatus according to the second embodiment. The information processing apparatus 100 according to the present embodiment includes a control unit 111, a switching detection unit 112, a communication log generation unit 113, a communication log storage unit 141, a roaming parameter configuration information storage unit 151, a threshold information storage unit 152, and a connection internet protocol (IP) address information storage unit 153. The information processing apparatus 100 is exclusively connected by a wireless LAN through an antenna (not illustrated) to a wireless communication device, such as the access point 201 or 202, that is connectable by the wireless LAN. For the present embodiment, the information processing apparatus 100 is connected to the access point 201 and is connectable to the access point 202.

The control unit 111 performs control on the basis of configuration information stored in the roaming parameter configuration information storage unit 151 such that the frequency of switching connection when occurrence of switching of connection detected by the switching detection unit 112 satisfies a given condition is lower than when the state does not satisfy the condition.

The control unit 111 determines whether a configured execution condition is satisfied. When the configured execution condition is satisfied, the control unit 111 switches the connection. The control unit 111 determines whether occurrence of switching of connection detected by the switching detection unit 112 satisfies a configuration condition indicated in configuration information stored in the roaming parameter configuration information storage unit 151. The control unit 111 changes the configured execution condition such that the frequency of switching connection when the occurrence of switching of connection satisfies the configuration information is lower than when the state does not satisfy the configuration condition.

The control unit 111 determines whether the currently connected access point 201 is the same as a preset wireless communication apparatus in an initial wireless LAN connection after startup. Here, in shifting to a power-off state (including a hibernation state) or to a suspend state at which the communication of the information processing apparatus 100 is inactive, the control unit 111 stores, in the connection IP address information storage unit 153, the IP address of a wireless communication apparatus that is being connected before the start of the shifting operation as connection IP address information. At the startup or wireless LAN connection by resuming, the control unit 111 determines on the basis of this information whether the IP address of the currently connected access point 201 is the same as the IP address of the wireless communication apparatus that was connected in the preceding operation. When the IP address of the currently connected access point 201 is different from the IP address of the wireless communication apparatus that was connected in the preceding operation, the control unit 111 configures the threshold of threshold information in roaming parameter configuration information at its initial state.

The switching detection unit 112 extracts an event ID that indicates switching of connection from an event log stored in the communication log storage unit 141. For example, this event ID is “4201.” The switching detection unit 112 detects, on the basis of this event ID, occurrences of switching of connection from the access point 201 to the access point 202 and switching of connection from the access point 202 to the access point 201.

The communication log generation unit 113 generates a communication log, such as the occurrence of switching of connection detected by the switching detection unit 112 and an event log that indicates another event, and causes the communication log storage unit 141 to store that communication log. This enables recording an event relating to communication of, for example, the event ID “4201” that occurs in the information processing apparatus 100.

The communication log storage unit 141 stores a communication log, such as an event log. The event log indicates an event relating to communication occurring in the information processing apparatus 100 and the time of the occurrence of that event.

The roaming parameter configuration information storage unit 151 stores configuration information that configures a relationship between occurrence of switching of connection and a frequency of switching connection. The roaming parameter configuration information storage unit 151 stores configuration information on the basis of the occurrence of switching of connection. The configuration information indicates a condition for selecting one execution condition from among a plurality of execution conditions in threshold information stored in the threshold information storage unit 152. The configuration information indicates that the configured execution condition is to be changed such that the frequency of switching connection is reduced on condition that switching of connection has continuously occurred for a given period of time.

The threshold information storage unit 152 stores threshold information that indicates a plurality of execution conditions for determining whether a connection is to be switched. The information processing apparatus 100 selects one from among the plurality of execution conditions on the basis of configuration information and configures it. The information processing apparatus 100 determines on the basis of the configured execution condition whether the connection is to be switched. The threshold information may be radio-wave strength threshold information regarding the strength of radio waves, for example. The information processing apparatus 100 measures the strength of radio waves received from the access point 201 or 202. The execution condition indicated by the radio-wave strength threshold information is configured on the basis of the strength of radio waves received by the information processing apparatus 100 from the access point 201 currently connected thereto by a wireless LAN. In this case, the execution condition is configured such that, when the strength of radio waves is less than a given threshold, the connection with the access point 201 or 202 is switched. The threshold information may be threshold information regarding a dropping rate of packets, for example. The information processing apparatus 100 receives a beacon signal regularly transmitted from the access point 201 or 202. The above-described dropping rate of packets may be the proportion of the number of times the information processing apparatus 100 has lost a beacon signal from the access point 201 or 202 (the number of times it has failed to receive a beacon signal) within a given period of time, for example. In this case, the threshold information is configured such that, when the dropping rate of packets is equal to or more than a given threshold, the connection with the access point 201 or 202 is switched. The threshold information functions as switching execution information.

In the processing of switching connection, if the connectable access point 202 exists other than the currently connected access point 201, the information processing apparatus 100 establishes connection with the connectable access point 202. In contrast, in the processing of switching connection, if there is no connectable access point other than the access point 201, the information processing apparatus 100 continues connection with the access point 201.

The connection IP address information storage unit 153 stores connection IP address information that indicates the IP address of a wireless communication apparatus that was connected in the preceding operation of the information processing apparatus 100 (e.g., access point 201). This enables retaining the IP address of a wireless communication apparatus to which the information processing apparatus 100 was connected in the preceding operation.

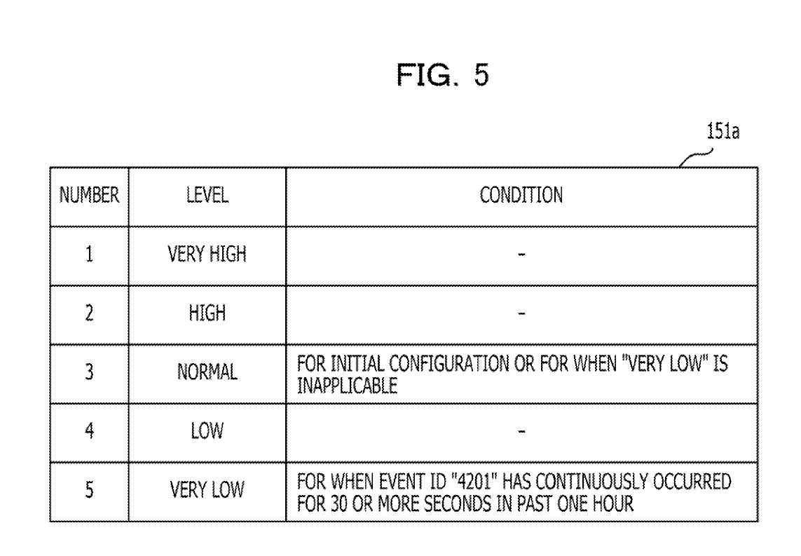

FIG. 5 illustrates a roaming parameter configuration table according to the second embodiment. A roaming parameter configuration table 151a illustrated in FIG. 5 is stored in the roaming parameter configuration information storage unit 151. The roaming parameter configuration table 151a is a table in which roaming parameter configuration information that configures a relationship between a roaming parameter for use when the information processing apparatus 100 is connected with the access points 201 and 202 by a wireless LAN and a condition for configuring the roaming parameter is stored.

The roaming parameter configuration table 151a has “number,” “level,” and “condition” as items. In the roaming parameter configuration table 151a, pieces of information in the items horizontally aligned are associated with each other as roaming parameter configuration information.

The roaming parameter is a parameter that configures a threshold for determining whether roaming for switching an access point currently connected to the information processing apparatus 100 to another access point that is assumed to establish a more stable communication is to be executed.

The number in the table is a number assigned in configuration of a roaming parameter. The level in the table indicates a name of the configuration of a roaming parameter. For the present embodiment, the configuration of a roaming parameter indicates a threshold for determining whether switching by roaming is to be executed, for example, a strength of radio waves received from the currently connected access point 201. The level is configured such that the frequency of the execution of roaming is the highest at “very high,” the frequency of execution of roaming reduces downwardly in FIG. 5, and the frequency of execution of roaming is the lowest at “very low.” In the following description, a value of the strength of radio waves is represented as a percentage under a given criterion.

One example case where, when the configured level is “very high,” the threshold of the strength of radio waves is 70% is discussed. In this case, if 70% or more of the strength of radio waves of radio waves received from the currently connected access point 201 is detected, switching by roaming is not executed; if less than 70% thereof is detected, switching by roaming is executed. When the configured level is “high,” the threshold of the strength of radio waves is 60%, for example. When the configured level is “normal,” the threshold of the strength of radio waves is 50%, for example. When the configured level is “low,” the threshold of the strength of radio waves is 40%, for example. When the configured level is “very low,” the threshold of the strength of radio waves is 30%, for example.

The roaming parameter in the present embodiment uses the strength of radio waves received from the currently connected access point 201 as a threshold for execution of roaming. Alternatively, however, the roaming parameter may use the dropping rate of packets from the currently connected access point 201 as the threshold for execution of roaming.

The condition indicates a condition at which the roaming parameter is configured at each level. When the state of the information processing apparatus 100 meets an illustrated condition, the level corresponding to that condition is configured as the roaming parameter.

In controlling a roaming parameter according to the present embodiment, “normal” and “very low” are configured as the level of the roaming parameter. At initial configuration of the information processing apparatus 100, such as the startup, or when the condition of “very low,” which is described below, is not met, the roaming parameter is configured at “normal.” If, in determination of a configuration of a roaming parameter, the event ID “4201” has continuously occurred for 30 or more seconds in the past one hour, the roaming parameter is configured at “very low.” Here, the event ID “4201” indicates detection of new configuration of an IP address in the information processing apparatus 100. For the present embodiment, by the use of the event ID “4201,” an access point connected to a network is changed and execution of switching processing by roaming is detected.

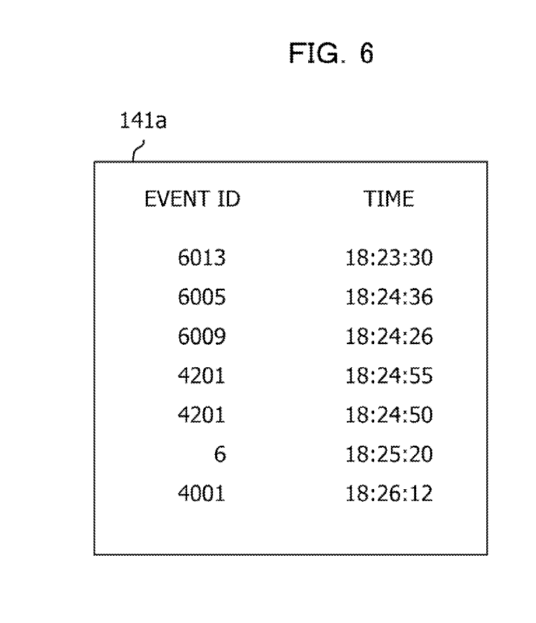

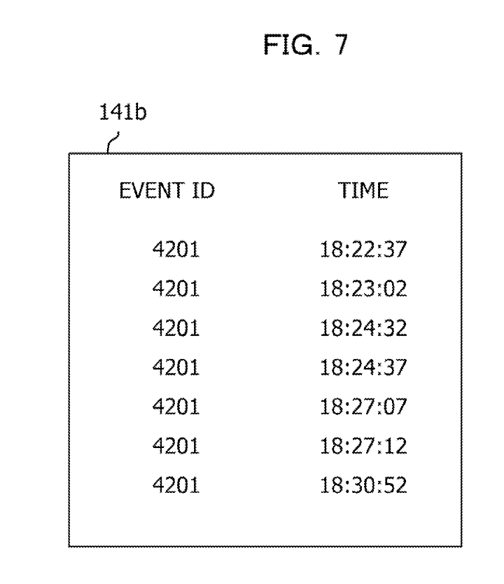

FIGS. 6 and 7 illustrate event logs according to the second embodiment. Event logs 141a and 141b illustrated in FIGS. 6 and 7 are generated and managed by the information processing apparatus 100. The event logs 141a and 141b are data that indicates event logs recorded when the use state is changed, the configuration is changed, or an event, such as an error, occurs in the information processing apparatus 100. The event logs 141a and 141b are generated by the communication log generation unit 113 and stored in the communication log storage unit 141.

The event logs 141a and 141b have an “event ID” assigned to identify an event that occurs in the information processing apparatus 100 and “time” indicating the time of the occurrence of the event. Pieces of information in the items horizontally arranged are associated with each other, and an event log corresponding to the occurrence of a single event is provided.

Every time an event occurs in the information processing apparatus 100, the communication log generation unit 113 generates an event log illustrated in each row of the event logs 141a and 141b and causes the communication log storage unit 141 to store it.

The event log 141a illustrated in FIG. 6 is an example of an event log when the connection between the information processing apparatus 100 and the access point 201 is stable. When the connection between the information processing apparatus 100 and the access point 201 by a wireless LAN is stable, as illustrated in the event log 141a, the frequency of the event ID “4201” is low.

The event log 141b illustrated in FIG. 7 is an example of an event log when the connection between the information processing apparatus 100 and the access point 201 is unstable. When the connection between the information processing apparatus 100 and the access point 201 by a wireless LAN is unstable, as illustrated in the event log 141b, the frequency of the event ID “4201” is high. For example, when the present time is 18:31, the event log 141b indicates that the information processing apparatus 100 meets the condition for determining whether “switching of connection has continuously occurred” in wireless LAN diagnosis processing described below, e.g., the above-described condition “the event ID “4201” has continuously occurred for 30 or more seconds in the past one hour.” In response to this, the information processing apparatus 100 configures the roaming parameter at “very low,” where the condition for the threshold of occurrence of roaming processing is more strict, thereby suppressing the frequency of the roaming processing. With this, a high frequency of roaming between the information processing apparatus 100 and the access point 201 or 202 is reduced, and the information processing apparatus 100 is conducted stable communication.

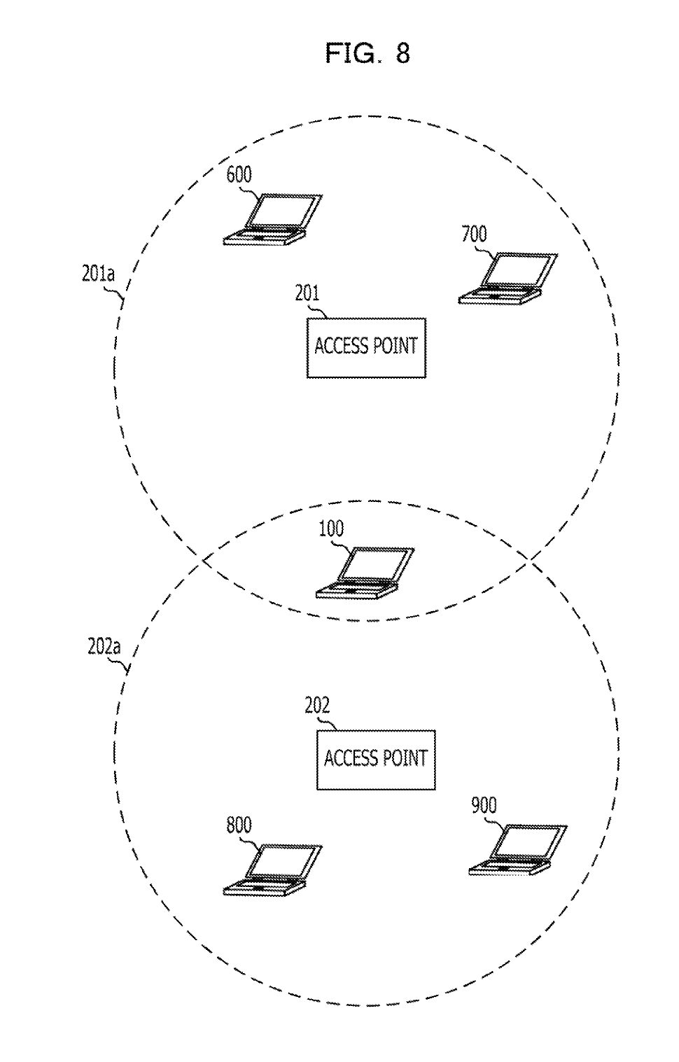

FIG. 8 illustrates a relationship between information processing apparatuses and access points according to the second embodiment. FIG. 8 illustrates a situation where the information processing apparatus 100, 600, 700, 800, and 900 make communications over the network 10 by connecting to the access point 201 or 202 by a wireless LAN.

An area where connection to the access point 201 can be established by a wireless LAN is defined as a wireless LAN accessible area 201a. The information processing apparatuses 100, 600, and 700 within the wireless LAN accessible area 201a are connected to the access point 201 by a wireless LAN. An area where connection to the access point 202 can be established by a wireless LAN is defined as a wireless LAN accessible area 202a. The information processing apparatuses 100, 800, and 900 within the wireless LAN accessible area 202a are connected to the access point 202 by a wireless LAN.

In FIG. 8, the information processing apparatus 100 is included in both the wireless LAN accessible areas 201a and 202a. Therefore, because the information processing apparatus 100 can connect to both of the access points 201 and 202, if the threshold of a roaming parameter is exceeded, roaming occurs. At this time, depending on the threshold of the roaming parameter, roaming may frequently occur. In contrast to this, the information processing apparatus 100 according to the present embodiment monitors the frequency of roaming and changes the threshold of the occurrence of roaming on the basis of the monitoring in wireless LAN diagnosis processing described below. This enables suppressing the occurrence of roaming if the frequency of roaming is high and stabilizing a connection between the information processing apparatus 100 and the access point 201 by a wireless LAN.

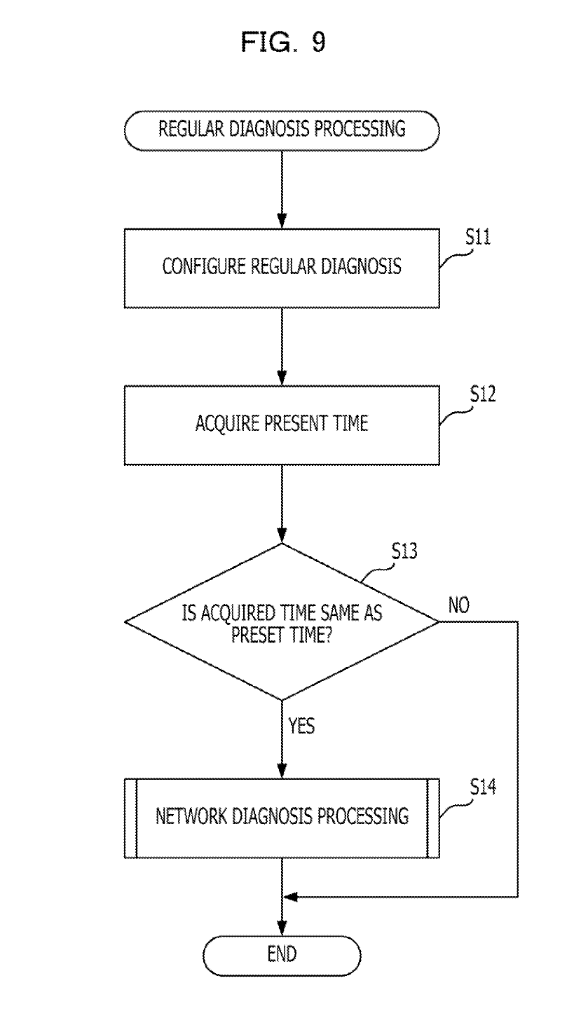

FIG. 9 is a flowchart that illustrates a procedure of regular diagnosis processing according to the second embodiment. The regular diagnosis processing illustrated in FIG. 9 is processing of controlling a determination regarding whether the information processing apparatus 100 is to execute network diagnosis processing described below. The regular diagnosis processing according to the present embodiment may be always or regularly performed when the information processing apparatus 100 is connected to a network.

[Operation S11] The control unit 111 acquires a current communication status of the information processing apparatus 100, such as a method used in connection of the information processing apparatus 100 to a network (e.g., wired LAN or wireless LAN) and a connected device (e.g., the access point 201 or 202), and configures items for a regular diagnosis in network diagnosis processing described below.

[Operation S12] The control unit 111 acquires a present time. The control unit 111 may acquire this present time from a timer included in the CPU 101, for example.

[Operation S13] The control unit 111 compares the present time acquired at Operation S12 with a time previously set as a scheduled time of execution of the regular diagnosis. If it is determined that the acquired time and the previously set time match, the processing proceeds to Operation S14. If it is determined that they do not match, the processing ends.

[Operation S14] The control unit 111 executes the network diagnosis processing, which is described below. After that, the processing ends.

In the regular diagnosis processing according to the present embodiment, a present time is acquired after the items of the regular diagnosis are configured, and it is determined whether the present time is the time of execution of the regular diagnosis. Alternatively, however, in the regular diagnosis processing, the items of the regular diagnosis may be configured after the present time is acquired. Alternatively, in the regular diagnosis processing, the items of the regular diagnosis may be configured after it is determined whether the present time is the time of execution of the regular diagnosis. That is, the sequence of executions of the operations in the regular diagnosis processing may be changed if needed.

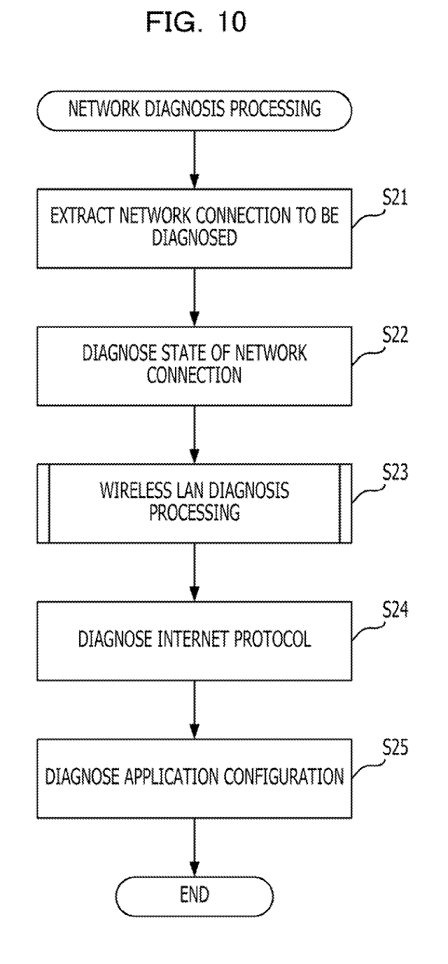

FIG. 10 is a flowchart that illustrates a procedure of the network diagnosis processing according to the second embodiment. The network diagnosis processing illustrated in FIG. 10 is processing in which the information processing apparatus 100 diagnoses a state of a currently connected network or a connectable network. The network diagnosis processing according to the present embodiment is executed on the basis of a call from the regular diagnosis processing executed in the information processing apparatus 100 or a request to diagnose a state of a network from a user.

[Operation S21] The control unit 111 extracts a network connection being a diagnosis target, such as a network to which the information processing apparatus 100 is currently connected or a connectable network (e.g., wired LAN or wireless LAN).

[Operation S22] The control unit 111 diagnoses a state of the network connection. At this time, the control unit 111 determines whether each network connection being a diagnosis target is available or unavailable and records the determination.

[Operation S23] The control unit 111 executes wireless LAN diagnosis processing described below. At this time, the control unit 111 examines the presence or absence of radio waves transmitted from the information processing apparatus 100 and from an opposed wireless communication apparatus, ability or disability to establish a network connection by a wireless LAN, and presence or absence of an event that indicates an anomaly of a wireless LAN in an event log. The control unit 111 determines on the basis of the examination whether the wireless LAN functions normally and records the determination.

[Operation S24] The control unit 111 diagnoses the Internet protocol. At this time, the control unit 111 acquires the IP address of the information processing apparatus 100 and examines a gateway connection and effectiveness and records the examination.

[Operation S25] The control unit 111 diagnoses application configuration. At this time, the control unit 111 examines configuration of a browser and configuration of security software. After that, the processing ends. The network configuration is recovered from an anomaly on the basis of the results recorded at Operations S22 to S25. The results recorded at Operations S22 to S25 may be displayed to a user.

In the network diagnosis processing according to the present embodiment, after the wireless LAN diagnosis processing is performed, the internet protocol is diagnosed and configuration of an application is diagnosed. Alternatively, however, in the network diagnosis processing, after the Internet protocol is diagnosed, the wireless LAN diagnosis processing may be performed. Alternatively, in the network diagnosis processing, after configuration of an application is diagnosed, the wireless LAN diagnosis processing may be performed. That is, the sequence of executions of the operations in the network diagnosis processing may be changed if needed.

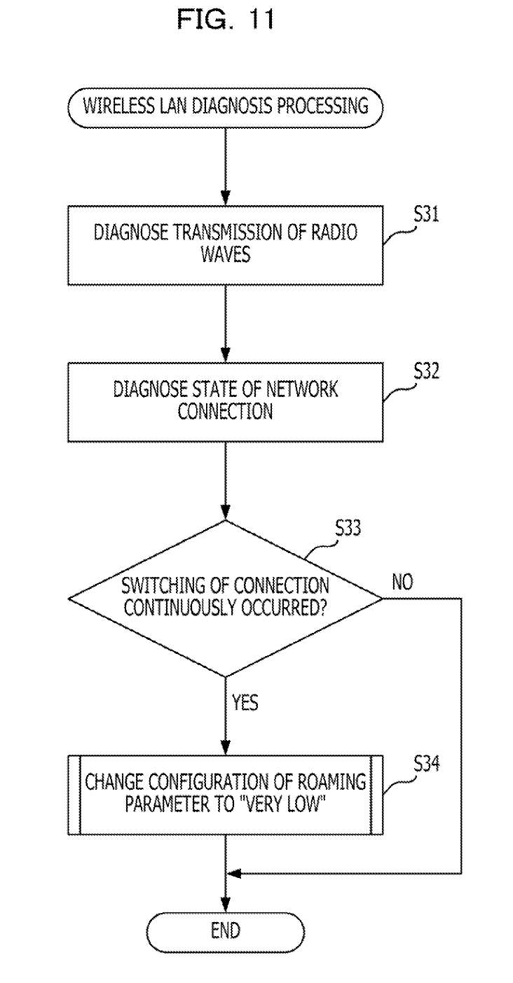

FIG. 11 is a flowchart that illustrates a procedure of the wireless LAN diagnosis processing according to the second embodiment. The wireless LAN diagnosis processing illustrated in FIG. 11 is processing in which the information processing apparatus 100 diagnoses a state of a currently connected wireless LAN or a connectable wireless LAN. The wireless LAN diagnosis processing according to the present embodiment is executed on the basis of a call from the network diagnosis processing executed in the information processing apparatus 100 or a request to diagnose a wireless LAN from a user.

[Operation S31] The control unit 111 diagnoses transmission of radio waves. For example, the control unit 111 determines whether radio waves are transmitted from the information processing apparatus 100 and its peripheral wireless LAN access point (e.g., access points 201 and 202) and records the determination.

[Operation S32] The control unit 111 determines whether the information processing apparatus 100 and a currently connected access point (e.g., access point 201) are normally connected and records the determination.

[Operation S33] The control unit 111 diagnoses a state of the network connection. For example, the control unit 111 determines whether switching of connection by roaming has continuously occurred between the information processing apparatus 100 and the currently connected access point 201 and another access point (e.g., access point 202) on the basis of roaming parameter configuration information. When switching of connection has continuously occurred, the processing proceeds to Operation S34; when switching of connection has not continuously occurred, the processing ends.

[Operation S34] The control unit 111 changes the configuration of roaming parameter configuration information to “very low.” After that, the processing ends.

In the wireless LAN diagnosis processing according to the present embodiment, after transmission of radio waves is diagnosed, a state of a network connection is diagnosed and it is determined whether switching of connection has continuously occurred. Alternatively, however, in the wireless LAN diagnosis processing, after it is determined whether switching of connection has continuously occurred, transmission of radio waves may be diagnosed. Alternatively, in the wireless LAN diagnosis processing, after it is determined whether switching of connection has continuously occurred, a state of a network connection may be diagnosed. That is, the sequence of executions of the operations in the wireless LAN diagnosis processing may be changed.

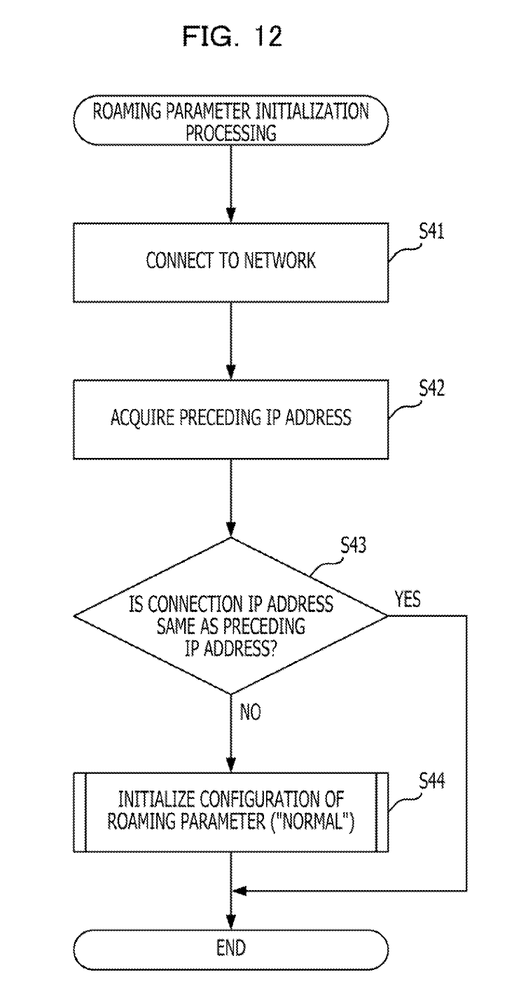

FIG. 12 is a flowchart that illustrates a procedure of roaming parameter initialization processing according to the second embodiment. The roaming parameter initialization processing illustrated in FIG. 12 is processing of initializing configuration of a roaming parameter indicated in roaming parameter configuration information at startup of the information processing apparatus 100. The roaming parameter initialization processing according to the present embodiment is executed on the basis of startup of the information processing apparatus 100.

[Operation S41] The control unit 111 becomes connected to a wireless communication apparatus on a network. At this time, the control unit 111 acquires the IP address of the wireless communication apparatus.

[Operation S42] The control unit 111 acquires the IP address of the wireless communication apparatus that was last connected to the information processing apparatus 100 in the preceding operation (e.g., access point 201) from the connection IP address information storage unit 153. As previously described, in shifting to a power-off state or to a suspend state at which the communication of the information processing apparatus 100 is inactive, the control unit 111 stores, in the connection IP address information storage unit 153, the connection IP address information that indicates the IP address of the last connected access point 201. This IP address enables identifying the wireless communication apparatus. Instead of the IP address, a media access control (MAC) address or other information by which a wireless communication apparatus may be uniquely identified may also be used.

[Operation S43] The control unit 111 determines whether the IP address of the wireless communication apparatus acquired at Operation S41 at this startup and the IP address of the last connected access point 201 in the preceding operation acquired at Operation S42 are the same. When both IP addresses are the same, the processing ends. When both IP address are not the same, the processing proceeds to Operation S44.

[Operation S44] The control unit 111 initializes configuration of roaming parameter configuration information (i.e., configures it at “normal”). After that, the processing ends.

For the present embodiment, connection IP address information that indicates the IP address of the last connected wireless communication apparatus in the preceding operation is stored, and it is determined whether the IP address indicated in the connection IP address information and the IP address of a wireless communication apparatus that is connected after startup of the information processing apparatus are the same. Alternatively, however, an IP address of a specified wireless communication apparatus may have been registered in advance in the information processing apparatus 100, and it may be determined whether the registered IP address and the IP address of a wireless communication apparatus that is connected after startup are the same.

In the roaming parameter initialization processing according to the present embodiment, after the information processing apparatus become connected to a network, the IP address of a wireless communication apparatus that was connected in the preceding operation is examined. Alternatively, however, in the roaming parameter initialization processing, after the IP address of a wireless communication apparatus that was connected in the preceding operation is examined, the information processing apparatus may become connected.

As described above, with the second embodiment, appropriately controlling switching of connection with a wireless communication apparatus by roaming is stabilized the wireless communication. For the second embodiment, in the initial wireless LAN network connection after startup of the information processing apparatus 100, when the connected wireless communication apparatus and a preset wireless communication apparatus are different, configuration of threshold information is changed to its initial state. This enables the information processing apparatus to operate without being subjected to unnecessary suppression of execution of switching of connection by roaming when the information processing apparatus is used under a new wireless LAN environment, for example.

For the second embodiment, in the initial wireless LAN network connection after startup of the information processing apparatus 100, when the connected wireless communication apparatus and a wireless communication apparatus that was connected in the preceding operation are different, configuration of threshold information is changed to its initial state. This enables the information processing apparatus to operate without being subjected to unnecessary suppression of execution of switching of connection by roaming when the information processing apparatus is used by a wireless LAN different from that in the preceding operation, for example.

In response to occurrence of switching of connection by roaming detected on the basis of an event indicated in an event log and a condition indicated in roaming parameter configuration information, configuration of threshold information that determines the frequency of switching connection by roaming is changed. This enables the frequency of switching connection by roaming to be controlled in response to the occurrence of switching of connection by roaming.

When switching of connection by roaming has continuously occurred for a given period of time, configuration of threshold information is changed such that the frequency of switching connection by roaming is reduced. This enables wireless communication to be stabilized when switching of connection by roaming has continuously occurred.

The information processing apparatus 100 determines on the basis of the strength of received radio waves whether switching of connection by roaming is to be performed and changes configuration of the strength of radio waves on the basis of roaming parameter configuration information. This enables the frequency of switching connection to be controlled by a change of a threshold represented as the strength of radio waves in response to occurrence of switching of connection by roaming. As a result, instability of wireless communication caused by a high frequency of switching of connection is suppressed.

The information processing apparatus 100 determines on the basis of the dropping rate of packets whether switching of connection by roaming is to be performed and changes the dropping rate of packets on the basis of roaming parameter configuration information. This enables the frequency of switching connection to be controlled by a change of a threshold represented as the dropping rate of packets in response to occurrence of switching of connection by roaming. As a result, instability of wireless communication caused by a high frequency of switching of connection is suppressed.

The information processing apparatus 100 changes configuration of threshold information to its initial state when, in the initial wireless LAN network connection after startup of the information processing apparatus 100, the IP address of the currently connected wireless communication apparatus and a previously registered IP address are different. This enables the information processing apparatus 100 to operate without being subjected to unnecessary suppression of execution of switching of connection by roaming when the information processing apparatus is connected to a wireless communication apparatus that has not been registered in advance.

In shifting to a power-off state or to a suspend state at which communication is inactive, the information processing apparatus 100 stores the IP address of a currently connected wireless communication apparatus. The information processing apparatus 100 determines at its startup whether it is connected to the last connected wireless communication apparatus in the preceding operation using the stored IP address. This determines whether the currently used wireless LAN environment is substantially the same as the preceding wireless LAN environment. When it is determined that it is connected to a wireless communication apparatus different from that in the preceding operation, the information processing apparatus 100 operates without being subjected to unnecessary suppression of execution of switching of connection by roaming.

The above-described processing functions are achieved by a computer. In this case, a program that describes the details of the processing of the functions which the information processing apparatus 100 is provided. Executing that program on a computer achieves the above-described processing functions on the computer. The program describing the details of the processing may be recorded on a computer-readable recording medium. Examples of the computer-readable recording medium include a magnetic storage device, an optical disk, a magneto-optical recording medium, and semiconductor memory. Examples of the magnetic storage device include a hard disk drive (HDD), a flexible disk (FD), and magnetic tape. Examples of the optical disk include a Blu-ray Disk®, a DVD, a DVD-RAM, and a CD-ROM/RW. Examples of the magneto-optical recording medium include a magneto-optical disk (MO).

To distribute a program, a portable recording medium, such as a DVD or a CD-ROM, on which the program is recorded may be sold. The program may be stored in a storage device of a server computer and may be transferred from the server computer to another computer over a network.

A computer for executing a program stores a program recorded on a portable recording medium or a program transferred from a server computer in its own storage device. The computer may read the program from its own storage device and executes processing in accordance with the program. The computer may directly perform processing in accordance with the program read from the portable recording medium. The computer may perform processing in accordance with a received program every time the program is transferred from a server computer connected over a network.

At least part of the above-described processing functions may be achieved by an electronic circuit, such as a digital signal processor (DSP), an application specific integrated circuit (ASIC), or a programmable logic device (PLD).

In the foregoing, disclosed wireless communication apparatus, program, and method of controlling wireless communication are described on the basis of illustrated embodiments. The structure of each unit may be replaced with any structure that has substantially the same function. Any other component or operation may be added to the disclosed technique. The disclosed technique may be a combination of any two or more structures in the above-described embodiments.

The foregoing illustrates merely the principle of the present invention. Additionally, the disclosed technique can be variously modified or changed by those skilled in the art and is not limited to the precise structure illustrated and described above and an application example thereof. Corresponding modifications and equivalents are considered as being in the scope of the present invention indicated by the attached claims and their equivalents.

All examples and conditional language recited herein are intended for pedagogical purposes to aid the reader in understanding the invention and the concepts contributed by the inventor to furthering the art, and are to be construed as being without limitation to such specifically recited examples and conditions. Although the embodiment(s) of the present inventions have been described in detail, it should be understood that the various changes, substitutions, and alterations could be made hereto without departing from the spirit and scope of the invention.

What is claimed is:

1. A wireless communication apparatus comprising:
a first storage unit that stores configuration information that configures a relationship between occurrence of switching of a wireless communication apparatus and a frequency of the occurrence of switching;
a switching detection unit that detects the occurrence of switching of other wireless communication apparatus currently connected by wireless communication; and
a control unit that performs control on a basis of the configuration information such that the frequency of switching when the detected occurrence of switching satisfies a given condition is lower than that when the occurrence of switching does not satisfy the given condition.

2. The wireless communication apparatus according to claim 1, further comprising:
a second storage unit that stores switching execution information that indicates a plurality of execution conditions to determine whether the switching is to be performed,
wherein the first storage unit stores configuration information that indicates a configuration condition to configure an execution condition from among the plurality of execution conditions in the switching execution information on a basis of the occurrence of switching,
when determining that the configured execution condition is satisfied, the control unit performs the switching and determines whether the detected occurrence of switching satisfies the configuration condition indicated in the configuration information, and
when determining that the detected occurrence of switching satisfies the configuration condition, the control unit changes the configured execution condition such that the frequency of switching is lower than when it is determined that the occurrence of switching does not satisfy the configuration condition.

3. The wireless communication apparatus according to claim 1, wherein, in connection by wireless communication after startup of the wireless communication apparatus, the control unit determines whether a currently connected wireless communication apparatus and a preset wireless communication apparatus are substantially the same, and
when determining that the currently connected wireless communication apparatus and the preset wireless communication apparatus are different, the control unit configures a first execution condition.

4. The wireless communication apparatus according to claim 3, wherein, in the connection by wireless communication after the startup, the control unit determines whether the currently connected wireless communication apparatus and a wireless communication apparatus that was connected in a preceding operation are substantially the same, and
when determining that the currently connected wireless communication apparatus and the wireless communication apparatus that was connected in the preceding operation are different, the control unit configures a second execution condition.

5. The wireless communication apparatus according to claim 2, wherein the configuration information indicates that the configured execution condition is to be changed such that the frequency of switching is reduced on condition that the switching has continuously occurred for a given period of time.

6. The wireless communication apparatus according to claim 2, wherein the execution condition relates to a strength of radio waves received from the wireless communication apparatus currently connected by wireless communication.

7. The wireless communication apparatus according to claim 2, wherein the execution condition relates to a dropping rate of packets transmitted from the wireless communication apparatus currently connected by wireless communication.

8. The wireless communication apparatus according to claim 1, further comprising:
a communication log generation unit that generates a communication log that indicates the detected occurrence of switching,
wherein the switching detection unit detects the occurrence of switching on a basis of the communication log.

9. The wireless communication apparatus according to claim 3, further comprising:
a third storage unit that stores connection address information indicating an address of a wireless communication apparatus that was connected in a preceding operation,
wherein, in the connection by wireless communication after the startup, the control unit acquires an address of the currently connected wireless communication apparatus, and
when determining that the acquired address and the address indicated by the connection address information are different, the control unit configures a third execution condition.

10. The wireless communication apparatus according to claim 9, wherein, in shifting of the wireless communication apparatus to a communication inactive state, the control unit acquires the address of the currently connected wireless communication apparatus and causes the third storage unit to store connection address information that indicates the acquired address.

11. A method of controlling wireless communication executable in an apparatus that can perform wireless communication, the method comprising:
detecting, using a processing circuit of the apparatus, occurrence of switching of other wireless communication apparatus currently connected by wireless communication;
performing control using the processing circuit on a basis of configuration information stored in a storage device that configures a relationship between occurrence of switching and a frequency of the occurrence of switching such that the frequency of switching when the detected occurrence of switching satisfies a given condition is lower than that when the occurrence of switching does not satisfy the given condition.

12. The method of controlling wireless communication according to claim 11, further comprising:
recording using the processing circuit, in a storage device, configuration information that indicates a configuration condition to configure an execution condition from among a plurality of execution conditions in switching execution information on a basis of the occurrence of switching,
when determining that the configured execution condition is satisfied, performing using the processing circuit the switching and determining whether the detected occurrence of switching satisfies the configuration condition indicated in the configuration information, and
when determining that the detected occurrence of switching satisfies the configuration condition, changing using the processing circuit configuration of the execution condition such that the frequency of switching is lower than when it is determined that the occurrence of switching does not satisfy the configuration condition.

13. The method of controlling wireless communication according to claim 11, further comprising:
in connection by wireless communication after startup of the apparatus, determining using the processing circuit whether a currently connected wireless communication apparatus and a preset wireless communication apparatus are substantially the same, and
when determining that the currently connected wireless communication apparatus and the preset wireless communication apparatus are different, configuring using the processing circuit a first execution condition.

14. The method of controlling wireless communication according to claim 13, further comprising:
in the connection by wireless communication after the startup of the apparatus, determining using the processing circuit whether the currently connected wireless communication apparatus and a wireless communication apparatus that was connected in a preceding operation are substantially the same, and
when determining that the currently connected wireless communication apparatus and the wireless communication apparatus that was connected in the preceding operation are different, configuring using the processing circuit a second execution condition.

15. The method of controlling wireless communication according to claim 12, wherein the configuration information indicates that the configured execution condition is to be changed such that the frequency of switching is reduced on condition that the switching has continuously occurred for a given period of time.

16. The method of controlling wireless communication according to claim 12, wherein the execution condition relates to a strength of radio waves received from the wireless communication apparatus currently connected by wireless communication.

17. The method of controlling wireless communication according to claim 12, wherein the execution condition relates to a dropping rate of packets transmitted from the wireless communication apparatus currently connected by wireless communication.

18. The method of controlling wireless communication according to claim 11, further comprising:
generating, using the processing circuit, a communication log that indicates the detected occurrence of switching, and
recording, using the processing circuit, the communication log in a storage device,
wherein the detecting is detected the occurrence of switching on a basis of the communication log.

19. The method of controlling wireless communication according to claim 13, further comprising:
recording using the processing circuit, on a storage device, connection address information indicating an address of a wireless communication apparatus that was connected in a preceding operation of the apparatus,
in the connection by wireless communication after the startup of the apparatus, acquiring using the processing circuit an address of the currently connected wireless communication apparatus, and
when determining that the acquired address and the address indicated by the connection address information are different, configuring using the processing circuit a third execution condition.

20. A non-transitory computer-readable recording medium on which a program for causing a computer to execute a method of controlling wireless communication is recorded, the method comprising:
detecting occurrence of switching of other wireless communication apparatus currently connected by wireless communication;
performing control on a basis of configuration information stored in a storage unit that configures a relationship between occurrence of switching and a frequency of the occurrence of switching such that the frequency of switching when the detected occurrence of switching satisfies a given condition is lower than that when the occurrence of switching does not satisfy the given condition.
